(19) United States
(12) Patent Application Publication
(10) Pub. No.: US 2004/0117468 A1
(43) Pub. Date: Jun. 17, 2004

(54) Subscribing different quality of service by simple classification

(76) Inventors: Linghsaio Wang, Irvine, CA (US); James Yik, Mission Viejo, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/318,737

(22) Filed: Dec. 12, 2002

(51) Int. Cl. G06F 15/173

(52) U.S. Cl. 709/223

(57) ABSTRACT

A multi-fields (MF) classifier that categorizes each packet into a “QoS index,” instead of a priority queue number directly. The invention comprises two steps. The first step is to regroup the classified index based on its source port setting. The regrouping may combine two indexes into one, move around the classified category, or filer out traffic for access control purposes. The second step maps the index into different settings for all controllable resources. Some of the controllable resources include, but are not limited to, transmit priority on each egress port, dropping preference on each egress port, egress rate control preference, ingress rate control preference, and buffer resource class.

### BACKGROUND OF THE INVENTION

The present invention relates generally to prioritizing network traffic and more specifically to a classification system for use with Quality of Service (QoS) applications.

With the increasing popularity of the internet, network QoS has been a concern. Many efforts have been directed to value added Virtual Private Networks (VPN) type of flow based classification that can distinguish each individual end-to-end network connection and assign a guaranteed QoS on each flow. However, these implementations require enormous processing power and the settings tend to be more static due to lookup table complexity. This issue is not a big problem in the VPN market because the connection is usually static, for instance the connection between a company headquarters in San Francisco and a satellite office in Los Angeles, and quite expensive. These connections are usually handled by high end routers capable of handling multiples of tens of thousands of flows. Some semiconductor vendors offer devices that are dedicated to handling this type of tasks such as the CLASSIPI (™) from PMC-Sierra or the C-5 (™) network processor from Motorola.

Another method of implementing QoS is by classifying each packet on some standard field like the Internet Protocol (IP) type-of-service field or the TCP/UDP logical port that usually indicates the type of traffic for a packet. This method is commonly referred to as multi-fields (MF) classification in the Diffserv architecture (RFC 2475). This kind of task requires a lot less processing power, and because the classification rules are well known and widely used standard fields are used, the setting overhead is much is a lot smaller.

Most switching devices available today provide this kind of QoS classification, or a variant thereof. For public network access, this type of classification works better because of the dynamic nature of the network traffic. Simpler implementations have some inconvenient limitations. For example, once the packet is classified, the switch delivers it to the same priority category throughout the system, either through uplink or downlink. In order to satisfy different subscribers' requirements, the queuing method on the access side is usually over provisioned, for example having four queues or eight queues per access port with many different configurations for different needs, and there is no way to differentiate a different source on the uplink port. One method used to resolve this limitation is by implementing the aforementioned per-flow classification which can be expensive to implement. Thus, what is needed is a method to classify traffic based on standard fields that is easy and cost-effective to implement with priority category re-mapping based on either the source or destination setting, especially for a public internet access device.

### BRIEF SUMMARY OF THE INVENTION

In view of the aforementioned needs, the invention contemplates a multi-fields (MF) classifier that categorizes each packet into a “QoS index,” instead of a priority queue number directly. The invention comprises two steps. The first step is to regroup the classified index based on its source port setting. The regrouping may combine two indexes into one, move around the classified category, or filer out traffic for access control purposes. The second step maps the index into different settings for all controllable resources. Some of the controllable resources include, but are not limited to, transmit priority on each egress port, dropping preference on each egress port, egress rate control preference, ingress rate control preference, and buffer resource class.

As those skilled in the art can readily appreciate, the present invention may be implemented in software, hardware, or a combination thereof.

Still other objects of the present invention will become readily apparent to those skilled in this art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without from the invention. Accordingly, the drawing and descriptions will be regarded as illustrative in nature and not as restrictive.

### BRIEF DESCRIPTION OF THE SEVERAL VIEWS OF THE DRAWING

The accompanying drawings incorporated in and forming a part of the specification, illustrates several aspects of the present invention, and together with the description serve to explain the principles of the invention. In the drawings:

FIG. 1 is a block diagram of the component parts of the present invention;

FIG. 2 is a block diagram of an example application of the present invention; and

FIG. 3 is a block diagram illustrating the steps of the method of the present invention.

### DETAILED DESCRIPTION OF INVENTION

Throughout this description, the preferred embodiment and examples shown should be considered as exemplars, rather than limitations, of the present invention.

The present invention contemplates a multi-fields (MF) classifier that categorizes each packet into a “QoS index,” instead of a priority queue number directly. The invention comprises two steps. The first step is to regroup the classified index based on its source port setting. The regrouping may combine two indexes into one, move around the classified category, or filer out traffic for access control purposes. The second step maps the index into different settings for all controllable resources. Some of the controllable resources include, but are not limited to, transmit priority on each egress port, dropping preference on each egress port, egress rate control preference, ingress rate control preference, and buffer resource class.

The two state re-mapping is done by two lookup tables at each stage. The first stage lookup table uses the category plus the source port ID as an index. The output of the first table is the regrouped category. The second lookup able uses only the regrouped number as an index and produces an output that comprises the transmit priority and the drop precedence setting on “every possible output port,” and the setting for every managed system resource. From this information, the output processor can differentiate service to every source and destination. For multicast traffic, one input packet can be treated significantly different on each output port. Because of the optimized priority combination on each output port, the queuing method can be significantly simplified in comparison to using the queue setting to differentiate the service.

The present invention enables a packet to be assigned different priorities based on a user. Where a packet is important to one user it can be assigned the highest priority, while at the same time it can be assigned as best effort to a second user or even inhibited from reaching a certain port. An advantage of this approach is to have a simpler designed classifier and not overly provision the transmission queue, while still achieving good and differentiated QoS to each subscriber's preference. A network operator also obtains good control of network access at a reasonable cost. The two step mapping of the present invention may reduce the number of outputs. For example, if a classifier is capable of recognizing sixteen different traffic types, the present invention may remap these traffic types into only eight possible results. Thus, the classifier of the present invention can be more efficient than the simple DiffServ type of classifier.

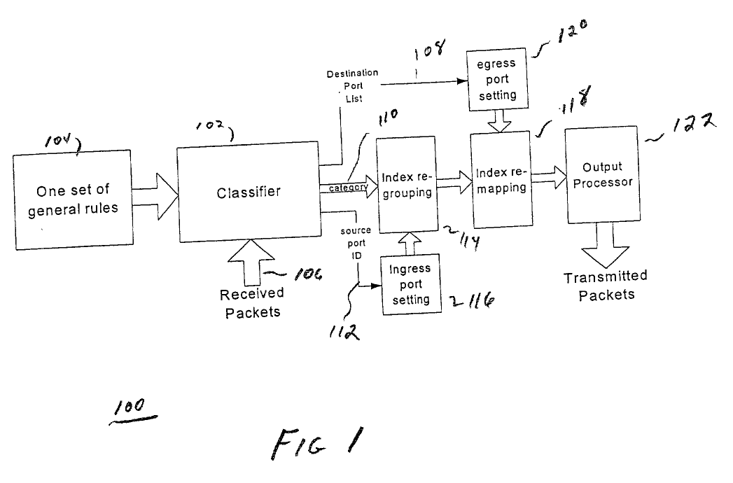

Referring now to FIG. 1 there is a block diagram 100 illustrating the process flow of the present invention. A classifier 102 receives a set of general rules 104 and received packets 106. The classifier produces three outputs, a destination port list 108, a category 110, and a source port ID 112, these outputs are received by the egress port setting 120, index re-grouping 114, and ingress port setting 116 respectively. The Index re-grouping 114 performs the first stage re-mapping and uses the category 110 and the source port ID 112 received from the ingress port setting 116 to produce a regrouped category (not shown) that is forwarded to the index re-mapping 118, which performs the second remapping. The index remapping 118 receiving the regrouped category from index regrouping 114 then uses the destination port link 108 provided by the egress port setting block 120 to produce the setting (not shown) for, every managed system resource. These settings and the packet are sent to the output processor 122 which uses the settings to differentiate the service to every source (not shown) and destination (not shown) and transmits the packets.

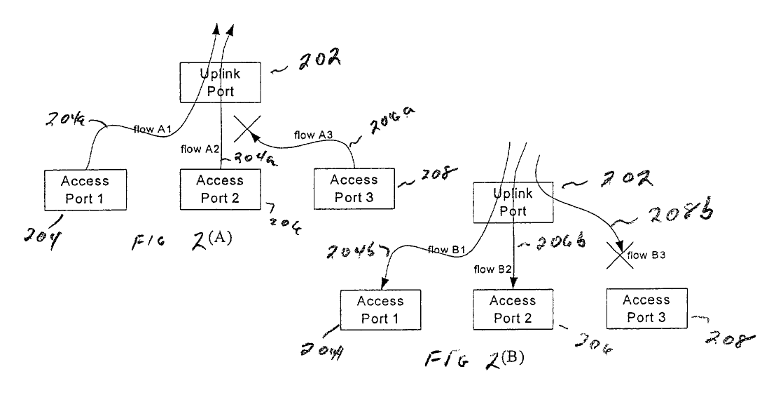

Referring now to FIGS. 2(A) and 2(B) there is illustrated an application in the POP of the access network. Each access port 204, 206, and 208 goes to a different subscriber and is connected to an uplink port 202. Flows to the uplink port 202 from the access ports 204, 206 and 208 are denoted 204a, 206a, and 208a respectively while flows from the uplink port 202 to the access ports 204, 206 and 208 are denoted 204b, 206b and 208b respectively. Depending on the subscriber's preference and the level of service subscribed, the setting of a particular traffic type on both directions can be different for each user. For example flows 204a, 206a and 208a may be the same traffic, however the user of access port 204 may have paid a premium service charge in order to get the possible service for that traffic type. The access port 204 recognizes this type of traffic and gives it a higher priority. However, the user on access port 206 may not care about this type of service while the user on access port 208 may not even be allowed to receive or transmit this type of traffic. With only one DiffServ classification and no remapping, the output queuing method for supporting this combination is very complicated. However, with the two step remapping function of the present invention, this kind of situation is easily solved. The system will recognize only one traffic type instead of six flows as would be implemented by the per flow classification method. The present invention enables a network operator to easily differentiate service to each subscriber, and hence generate additional revenues by differentiating the services, within a reasonable budget.

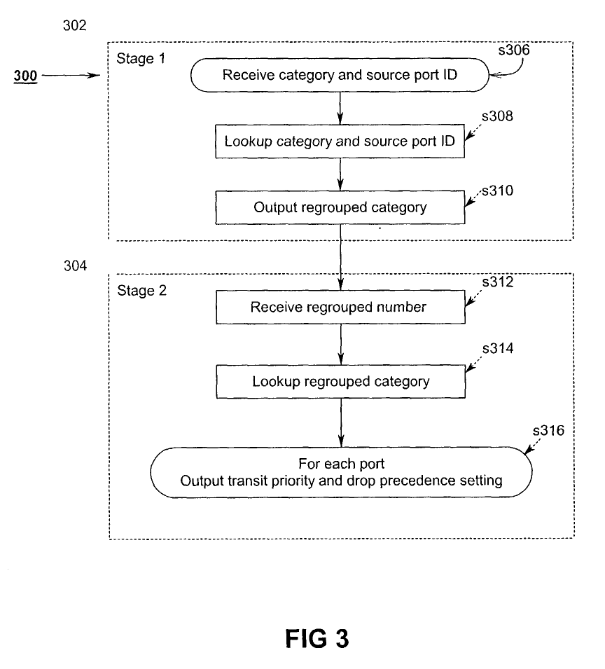

Referring now to FIG. 3, there is illustrated the steps for the method 300 of the present invention. The method 300 is essentially divided into two stages 302 and 304. The process begins at step s306 of stage 1,302, when the category and source port ID of the packet (not shown) is received. The next step, s308, is to lookup the category and source port ID, preferably in a table that is indexed by category and source port ID. Then at s310 the regrouped category is outputted to stage 2,304. At step s312 the regrouped number is received by stage 2,304. Then at step s314 a lookup of the regrouped number is performed which produces an output at step s316 comprising the output transit priority and precedence setting for each output port.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of the ordinary skill in the art to utilize the invention in various embodiments and with various modifications as are suited to the particular use contemplated. All such modifications and variations are within the scope of the invention as determined by the appended claims when interpreted in accordance to the breadth to which they are fairly, legally and equitably entitled.

What is claimed is:

1. A method for categorizing a packet, the steps comprising:
regrouping a classified index by its source port setting; and
mapping each controllable resource based on the classified index.

2. The method of claim 1 wherein the regrouping step uses a lookup table.

3. The method of claim 1 wherein the regrouping step further comprises producing a regrouped category based on a category and a source port identification of the packet.

4. The method of claim 1 wherein the regrouping step further comprises retrieving from a lookup table a regrouped category based on a category and a source port identification of the packet.

5. The method of claim 1 wherein the mapping step uses a lookup table.

6. The method of claim 1 wherein the mapping step further comprises producing a transmit priority for each possible output port.

7. The method of claim 1 wherein the mapping step further comprises producing a drop precedence setting for each possible output port.

8. The method of claim 1 wherein the regrouping step further comprises retrieving from a lookup table a regrouped category based on a category and a source port identification of the packet; and wherein the mapping step further comprises retrieving from a second lookup table a transmit priority for each possible output port based on the regrouped category.

9. The method of claim 8, the retrieving step further comprises retrieving from the second lookup table a drop precedence priority for each possible output port based on the regrouped category.

10. An apparatus for categorizing a packet, the steps comprising:
means for regrouping a classified index by its source port setting; and
means for mapping each controllable resource based on the classified index.

11. The apparatus of claim 10 wherein the regrouping means comprises a lookup table.

12. The apparatus of claim 10 wherein the regrouping means further comprises means for producing a regrouped category based on a category and a source port identification of the packet.

13. The apparatus of claim 10 wherein the regrouping means further comprises means for retrieving from a lookup table a regrouped category based on a category and a source port identification of the packet.

14. The apparatus of claim 10 wherein the mapping means comprises a lookup table.

15. The apparatus of claim 10 wherein the mapping means further comprises means for producing a transmit priority for each possible output port.

16. The apparatus of claim 10 wherein the mapping means further comprises means for producing a drop precedence setting for each possible output port.

17. The method of claim 10 wherein the regrouping means further comprises means for retrieving from a lookup table a regrouped category based on a category and a source port identification of the packet; and wherein the mapping means further comprises means for retrieving from a second lookup table a transmit priority for each possible output port based on the regrouped category.

18. The apparatus of claim 17, the retrieving means further comprises means for retrieving from the second lookup table a drop precedence priority for each possible output port based on the regrouped category.

19. A computer-readable medium of instructions for categorizing a packet, the steps comprising:
means for regrouping a classified index by its source port setting; and
means for mapping each controllable resource based on the classified index.

20. The computer-readable medium of instructions of claim 19 wherein the regrouping means comprises a lookup table.

21. The computer-readable medium of instructions of claim 19 wherein the regrouping means further comprises means for producing a regrouped category based on a category and a source port identification of the packet.

22. The computer-readable medium of instructions of claim 19 wherein the regrouping means further comprises means for retrieving from a lookup table a regrouped category based on a category and a source port identification of the packet.

23. The computer-readable medium of instructions of claim 19 wherein the mapping means comprises a lookup table.

24. The computer-readable medium of instructions of claim 19 wherein the mapping means further comprises means for producing a transmit priority for each possible output port.

25. The computer-readable medium of instructions of claim 19 wherein the mapping means further comprises means for producing a drop precedence setting for each possible output port.

26. The computer-readable medium of instructions of claim 19 wherein the regrouping means further comprises means for retrieving from a lookup table a regrouped category based on a category and a source port identification of the packet; and wherein the mapping means further comprises means for retrieving from a second lookup table a transmit priority for each possible output port based on the regrouped category.

27. The computer-readable medium of instructions of claim 26, the retrieving means further comprises means for retrieving from the second lookup table a drop precedence priority for each possible output port based on the regrouped category.
